(19) United States
(12) Patent Application Publication
(10) Pub. No.: US 2002/0147255 A1
(43) Pub. Date: Oct. 10, 2002

(54) Rubber mixture

(76) Inventors: Paul J. Kubicky, Newtown Square, PA (US); Charles C. Nygard, Lafayette Hill, PA (US); Maxwell Paul, Narberth, PA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 10/158,086

(22) Filed: May 29, 2002

Related U.S. Application Data
(63) Continuation-in-part of application No. 09/533,453, filed on Mar. 23, 2000.
Application No. 09/533,453 is a continuation-in-part of application No. 09/339,478, filed on Jun. 24, 1999, now Pat. No. 6,322,863.
Application No. 09/339,478 is a continuation-in-part of application No. 08/904,720, filed on Aug. 1, 1997, now abandoned.

(51) Int. Cl. C08L 1/00; C08J 3/00; C08K 5/00

(52) U.S. Cl. 524/81

(57) ABSTRACT

A mixture comprising ground scrap tire rubber of about between 15% and 85% by volume, ground polymeric filler of about between 10% and 80% by volume and a urethane binder of about 5% by volume. The mixture may be used to form environmentally friendly structures.

### CROSS-REFERENCE TO RELATED APPLICATIONS

This application is a continuation-in-part of U.S. patent application Ser. No. 09/533,453 filed Mar. 23, 2000, entitled “Elongated Member Formed Of A Rubber Mixture And Method of Making Thereof”, which is a continuation-in-part of U.S. patent application Ser. No. 09/339,478 filed Jun. 24, 1999 and entitled “Utility Pole With Pipe Column And Reinforcing Rods Comprised Of Scrap Rubber And Plastic”, now U.S. Pat. No. 6,322,863, which in turn is a continuation-in-part of U.S. patent application Ser. No. 08/904,720, filed Aug. 1, 1997 entitled, “Utility Pole With Pipe Column And Reinforcing Rods Comprised Of Scrap Rubber And Plastic” now abandoned.

### BACKGROUND OF THE INVENTION

The present invention relates to a rubber mixture employed for using recycled rubber and polymeric materials.

The recycling of tires and of certain polymeric or plastic materials is not a new idea. In the early 1900s, many tire manufacturers recycled scrap tires. However, as production costs declined, tire recycling almost disappeared, especially with the introduction of steel belted radial tires because of the difficulties involved in dealing with the steel belts. In the United States alone, there are in the vicinity of two hundred fifty to three hundred million scrap tires accumulating annually, in addition to an existing supply of over 500 million that are stockpiled, privately stored or illegally dumped. Waste scrap tires present landfill problems because they do not disintegrate and therefore they occupy an ever increasing volume as a result of such stockpiling. Such waste scrap tires also form fertile breeding grounds for mosquitoes, rats and the like.

Several methods for disposing of scrap tires have been developed and are currently being used. For example, cement kilns sometimes burn scrap tires as a source of energy. Such burning creates incredible amounts of dangerous emissions, which include lead, mercury, dioxins and furons (a recognized carcinogen). The burning of scrap tires is also an unnecessary waste of a viable resource, making burning an impracticable solution. Another popular method currently being employed involves mixing ground tire rubber into asphalt. This method has been shown to be ineffective and, in some cases, dangerous as evidenced in the “burning road” incident which occurred in Washington state. In addition, the steel remnants of tire buffings corrode and cause a reaction which potentially ignites the asphalt surface under high ambient temperatures. Further, asphalt containing rubber is costly, nearly double the cost of conventional asphalt. Another popular method for disposing of scrap tires is to form the scrap tires into crumb rubber. Crumb rubber is obtained from the chopping of the scrap tires through a grinder with the results being sifted through screens to reduce the tires to a crumb or mesh with different grades or textures. The present application addresses a new and improved use for the crumb rubber in molding recycling projects.

Polymeric materials, particularly plastic materials used in making containers also create disposal problems. Since the practice of landfilling such plastic materials has practically disappeared in the United States, state and local governments have been shouldered with the responsibility of recycling such plastic materials. Plastic materials also present a major problem in reclaiming projects. Because each type of plastic melts at a different temperature and the process by which the plastic is made creates imperfect end products, the plastic industry has faced many obstacles in making reliable products. It has become the practice of plastic manufacturers to mix the recycled plastic material with virgin plastic and additives. However, large amount of toxins are produced when melting plastics and millions of pounds of plastic each year are deemed unacceptable for use in recycling. Such plastic materials end up being shipped overseas for disposal. As with scrap tires, polymeric or plastic materials can be ground into pellets through the use of standard grinders.

The present invention, in one embodiment, comprises an elongated member which may be used in many different ways, including as a utility pole, which not only serves the purpose of disposing of scrap tires and ground plastic, but also serves to save the old growth forests which are being destroyed for the production of traditional wood utility poles. Currently, in the United States, over one hundred million utility poles are in place and as the communication age demands more telephone, cable or other utility lines, the demand for utility poles, both as new poles and as replacements for existing, unserviceable poles is continuously increasing. Wooden utility poles have numerous problems both structurally and environmentally. Such poles are usually treated with dangerous chemicals, such as creosote and pentachlorophenol, which not only leaches into the ground water but also prevents the use of such poles as landfill. Creosote, long used to treat utility poles, has been linked to health problems of the lungs and central nervous systems of animals and humans who are exposed to creosote for long periods of time. Preliminary studies are also finding such poles are an extreme danger to ground water.

Many have recognized the short comings of the wooden utility pole and have made an effort to replace such poles with substitute materials. Concrete poles, which crack and are extremely heavy and hard to transport, have been prevalent in warmer climates as a substitute. Aluminum poles have also gained popularity but are now causing headaches in metropolitan areas do to the increased risk of electrocution from wires that may be exposed at the base of such poles.

Some prior art patents have attempted to address the problem of scrap tire disposal through the construction of pole assemblies. U.S. Pat. No. 5,246,753 to Miller discloses a utility pole which is comprised of scrap motor vehicle tires which are cut and then glued together with a binder. However, utility poles made in accordance with the method described in the Miller patent lack any internal reinforcing structure and, therefore, are not readily useable for utility poles, particularly utility poles having a length greater than about ten feet. U.S. Pat. No. 5,714,219 of Mashukashey et al. discloses the use of shredded recycled tire particles for making a walking surface and, in one embodiment, a pole. The pole disclosed in this patent contains no reinforcing structure and, therefore, is not suitable for use as a utility pole. U.S. Pat. No. 5,094,905 of Murray discloses the use of shredded recycled tires for creating elongated flat structures such as landscape ties, dock bumpers or the like. Again, the structures disclosed in this patent contain no reinforcing structure and, therefore, they are completely unsuitable for use as poles, such as utility poles. U.S. Pat. Nos. 5,051,285 and 5,180,531 both to Borzankian teach the concept of an elongated pole which includes a reinforcing member surrounded by a plastic layer. However, Borzankian does not teach or even recognize the desirability of recycling scrap tires. Likewise, U.S. Pat. No. 5,675,956 to Nevin discloses a post or pole formed of a mixture of concrete and a filler material, such as rubber chips which are poured within an angular area between an inner polyvinlylchloride cylinder and an outer polyvinlylchloride cylinder. The post members are formed in predetermined lengths and are bolted together to form a pole such as a utility pole. However, the posts described in the Nevin patent is primarily formed of cement and utilizes only a small amount of rubber chips as a filler.

All of the above-identified patents suffer from several disadvantages. First, utility poles require structural integrity particularly as the length of the pole increases. Factors, such as wind and stress greatly effect the stability of a utility pole. Most of the above discussed patents have failed to take into consideration the need for any reinforcement in connection with the formation of a utility pole of a height of twenty feet or more. Second, segmented poles that are joined or coupled together as in the Nevin patent do not provide the necessary structural integrity for the lengths needed for utility poles. Third, most of the poles described above are uneconomical to produce. Finally, the method employed in making many of the discussed poles are not environmentally friendly, resulting in unnecessary pollution and the creation of potentially harmful toxins.

The present invention overcomes the disadvantages associated with the prior art by providing, in one embodiment, an elongated member or other structure such as a pole which is formed of a rubber mixture made of ground tire rubber. A pole or other structure made in accordance with the present invention is formed utilizing an environmentally friendly process which does not result in the release of toxins. Because of the composition of the rubber mixture, a pole or other structure made in accordance with the present invention is virtually indestructible, is not susceptible to decay and does not deteriorate as a result of being exposed to insects, birds, salt or other environmental conditions. Moreover, since poles or other structures made in accordance with the present invention are formed of scrap rubber tires, as more such poles or other structures are made, the number of scrap tires will significantly diminish thereby making good use of a valuable resource and diminishing an environmental problem.

### BRIEF SUMMARY OF THE INVENTION

Briefly stated, the present invention comprises a mixture of at least about 15% by volume of ground scrap tire rubber, about 80% by volume of a polymeric filler, at least about 5% by volume of an urethane binder, a fire retardant and an ultraviolet stabilizer.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1a cross-sectional elevational view, partially broken away, of an elongated pole member in accordance with a first preferred embodiment of the present invention;

FIG. 2 is a cross-sectional view of the pole member of FIG. 1 taken along line 2-2;

FIG. 3 is a cross-sectional view similar to FIG. 2, but illustrating a pole member in accordance with a second embodiment of the present invention;

FIG. 4 is a cross-sectional view similar to FIG. 2, but illustrating a pole member in accordance with a third embodiment of the present invention;

FIG. 5 is a cross-sectional view similar to FIG. 2, but illustrating a pole member in accordance with a fourth embodiment of the present invention;

FIG. 6 is a cross-sectional view similar to FIG. 2, but illustrating a pole member in accordance with a fifth embodiment of the present invention;

FIG. 7 is a cross-sectional elevational view, partially broken away, of a mold assembly illustrating a preferred method of making the pole member shown in FIG. 1;

FIG. 8 is a cross-sectional view taking along line 8-8 of FIG. 7; and

FIG. 9 is an enlarged cross-sectional elevational view of a bottom portion of the mold of FIG. 7 showing the making of a pole of the type shown in FIG. 3.

### DETAILED DESCRIPTION OF THE INVENTION

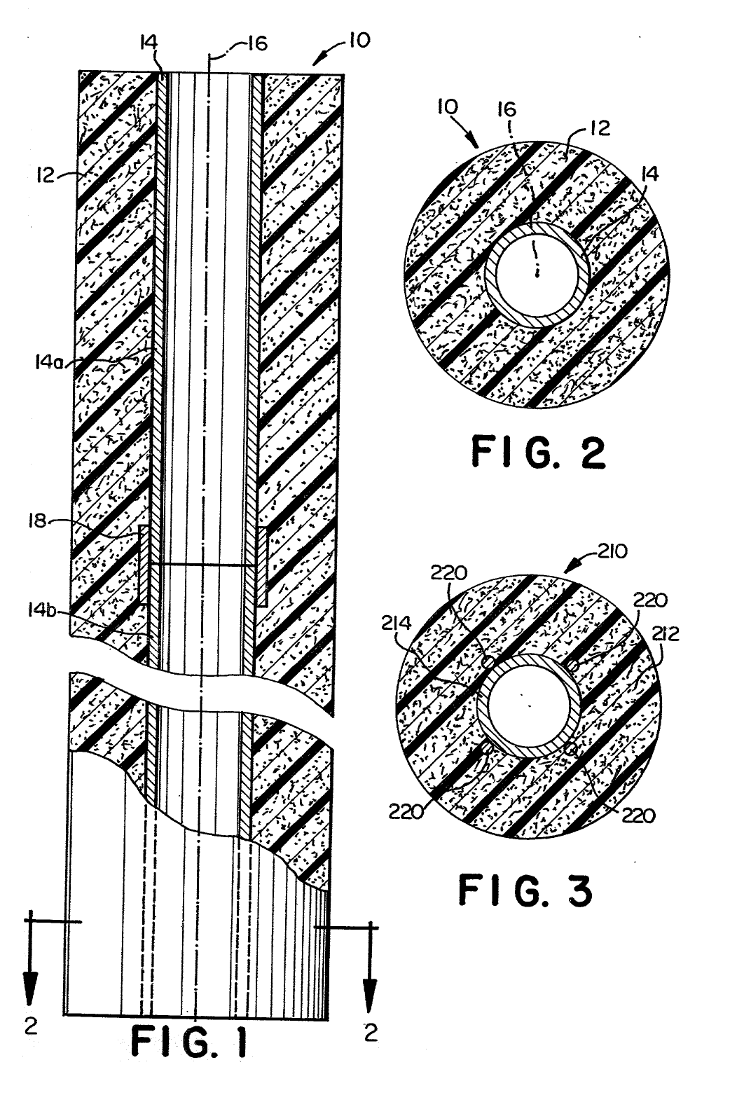

Referring the drawings, wherein like numerals are used to indicate like elements throughout the several figures, there is shown in FIGS. 1 and 2, a first preferred embodiment of an elongated member 10 in accordance with the present invention. The elongated member 10 of the present embodiment is a pole of the type which may be used as a utility pole for supporting wires, cables or the like. In the illustrated embodiment, the elongated pole member 10 is generally cylindrically shaped with a generally circular cross-section as shown in FIG. 2. It will be appreciated by those of ordinary skill in the art that the overall shape of the elongated pole member 10 may vary from the cylindrical shape as shown. For example, the elongated pole member 10 may have a cross-sectional shape of a triangle, square, pentagon, hexagon, octagon or any other suitable shape well known to those of ordinary skill in the art. Hence, the overall exterior shape of the elongated pole member 10 should not be considered to be a limitation upon the scope of the present invention. It will also be appreciated that the present invention is not limited to a pole or to a utility pole, but is an elongated member having many different end uses. For example, the elongated member 10 may be used as a bulkhead or as a part of a bulkhead, a guard rail, a median barrier, a piling or the like.

The elongated pole member 10 of the present embodiment is formed of a cured mixture 12 which includes at least ground rubber, a polymeric filler and a binder. In the present embodiment, the ground rubber portion of the mixture 12 is comprised of scrap rubber obtained from scrap or recycled tires in a ground form, commonly known as ground tire rubber. Preferably, the ground tire rubber comprises at least about 15% by volume of the mixture 12 which makes up the elongated pole member 10 and, more preferably, comprises about 65% by volume of the mixture 12. It will be appreciated by those of ordinary skill in the art that the precise volume percentage of the ground tire rubber within the mixture 12 may vary depending upon the particular end use of the elongated member 10 or other structure, the environmental conditions, which the elongated member 10 or other structure are expected to encounter, environmental conditions during the manufacturing process of the elongated member 10 or other structure, as well as other factors which are not necessary for a complete understanding of the present invention. For example, when a more rigid elongated member 10 or other structure is needed, a higher percentage of the polymeric filler is used and when a member with greater flexibility is needed a higher percentage of the ground tire rubber is used. The ground tire rubber could range from about 15% to about 85% by volume of the mixture 12. Therefore, it should be clearly understood that the present invention is not limited to a particular volume percentage of the ground tire rubber.

The mixture 12, which is employed for making the elongated pole member 10 or other structure further comprises a polymeric filler which in the present embodiment comprises ground, recycled polymeric or plastic material, preferably in the form of pellets. It will be appreciated by those of ordinary skill in the art that the ground polymeric pellets may be made up of virtually any type of ground polymeric material, including ground packaging material, such as blow molded bottles of the type typically recycled by many municipalities. Preferably, the ground polymeric material comprises less than about 80% by volume of the mixture 12 which forms the elongated pole member 10 or other structure and, more preferably, comprises about 25% by volume of the mixture 12. It will be appreciated by those of ordinary skill in the art that the type of ground polymeric filler material employed, the size of the pellets and the exact volume percentage of the polymeric filler material may vary depending upon the particular application and upon environmental and other factors. For example, the polymeric filler material could range from about 10% to about 80% by volume of the mixture 12. Therefore, it should be clearly understood that the present invention is not limited to a particular polymeric material or combination of materials and further is not limited to a particular volume percentage of the polymeric filler material.

The mixture 12 employed for making the elongated pole member 10 or other structure further includes a binder, which in the present embodiment preferably comprises a urethane polymer, preferably, Synair 2157 Prepolymer Duofome manufactured by Synair Corporation. Preferably, the urethane polymer binder comprises a quantity sufficient for wetting of the ground tire rubber and the polymeric filler, typically about 5% by volume of the mixture 12 which makes up the elongated pole member 10 or other structure. It will be appreciated by those of ordinary skill in the art that some other type of binder or even some other type of urethane polymer binder could alternatively be employed and that the precise volume percentage of the binder may vary in a particular application or with respect to certain environmental conditions. Therefore, it should be understood by those of ordinary skill in the art that the present invention is not limited to a particular binder or particular volume percentage of the binder used within the mixture 12.

Preferably, the mixture 12 further includes an ultraviolet stabilizer of the type well known to those of ordinary skill in the art and a fire retardant also of a type well known to those of ordinary skill in the art. Preferably, the ultraviolet stabilizer comprises less than about 6%, and, more preferably, about 1% by volume of the mixture 12. Preferably the fire retardant comprises less than about 5% and more preferably about 1% by volume of the mixture. It will be appreciated by those of ordinary skill in the art that for particular applications, the volume percentage of the ultraviolet stabilizer and/or the fire retardant may vary from the percentages specified above. Accordingly, it should be appreciated by those of ordinary skill in the art that the present invention is not limited to an elongated pole member 10, wherein the mixture 12 includes a particular volume percentage of the ultraviolet stabilizer or the fire retardant.

The elongated pole member 10 also includes a first elongated, rigid reinforcing member 14. The first reinforcing member 14 in the embodiment illustrated in FIGS. 1 and 2, is generally cylindrical and tubular and is generally concentric with the elongated pole member 10. That is, the elongated pole member 10 and the first reinforcing member 14 share a common central axis 16. Preferably, the first reinforcing member 14 extends substantially the entire axial length of the pole member 10. In the illustrated embodiment, the first reinforcing member 14 is comprised of at least two sub members 14a and 14b, the ends of which are in an abutting relationship and are surrounded by a sleeve member 18. Preferably, the sleeve member 18 is also generally cylindrically shaped and has an interior dimension which is substantially the same as the exterior dimension of the reinforcing member 14 so that the sleeve member 18 substantially locks together the abutting sub members 14a and 14b of the first reinforcing member 14. The sleeve member 18 may be made of the same material as the first reinforcing member 14 or it may be made of some other suitable material. It will be appreciated by those of ordinary skill in the art that while the present embodiment illustrates a first reinforcing member having two or more separable sub members 14a, 14b, a first reinforcing member 14 of a single, integrated piece is also within the scope of the present invention.

As shown in FIG. 2, the elongated pole member 10 has a diameter which establishes the overall radial thickness thereof. Typically, an elongated pole member 10 which may be used as a utility pole has an overall radial thickness or diameter of approximately 10 inches. However, it will be appreciated by those of ordinary skill in the art that the present invention is not limited to an elongated member 10 having a particular radial thickness. Regardless of the overall radial thickness of the elongated pole member 10, the first reinforcing member 14 has an outer dimension which is less than the radial thickness of the elongated pole member 10 so that the first reinforcing member 14 is surrounded and substantially encapsulated by the mixture 12 which forms the elongated pole member 10. In an embodiment in which the radial thickness of the elongated pole member is approximately 10 inches, the first reinforcing member 14 may have an outer diameter in the range of 2-6 inches depending upon the particular application. Preferably, the radial thickness of the wall of the first reinforcing member 14 is in the range of one quarter inch to three-quarters inch, but could be of a lesser or greater thickness depending the particular end application of the elongated pole member 10. In the present embodiment, the first reinforcing member 14 is made of a high strength rigid material such as steel, stainless steel, aluminum or an aluminum alloy, a composite resin material, a polymeric material or the like. It will be appreciated by those of ordinary skill in the art that the precise material of the first reinforcing member 14 may vary depending upon the particular end use of the elongated pole member 10 and other factors such as the length of the pole member 10 and the environment in which the elongated pole member 10 is to be used. For example, in an elongated pole member 10 having an overall length of about 10-20 feet, a polymeric first reinforcing member 14 may be employed. In a longer elongated pole member 10, for example, 60-80 feet, a steel first reinforcing member 14 may be employed. The material used for the first reinforcing member 14 and/or the dimension of the first reinforcing member should not be considered as a limitation on the present invention.

FIGS. 3-6 illustrate alternate embodiments of the elongated pole member 10 illustrated in FIGS. 1 and 2. In the fourth embodiment, shown in FIG. 5, the elongated pole member 410 includes a ground tire rubber mixture 412 as described above in connection with the first embodiment and a first reinforcing member 414 also as described above in connection with the first embodiment. However, unlike the first embodiment, in the embodiment shown in FIG. 5, the same ground tire rubber mixture 412a is installed within the interior of the first reinforcing member 414 to provide added strength and stability to the resulting elongated pole member 410 and to permit the elongated pole member 410 to have a longer length.

The second embodiment of an elongated pole member 210 is shown in FIG. 3. The elongated pole member 210 is made of the same ground tire rubber mixture 212 as described above in connection with the first embodiment and includes a first reinforcing member 214 which is substantially the same as described above in connection with the first embodiment. However, the second embodiment of the elongated pole member 210 further includes a second elongated, rigid generally cylindrical reinforcing member 220. In fact, in the illustrated embodiment, the pole member 210 includes four such second reinforcing members 220 which are generally equally circumferentially spaced around and abut the outer radial surface of the first reinforcing member 214. The second reinforcing member or members 220 provide additional structural support and stability, particularly for poles having a length in excess of forty feet. It will be appreciated by those of ordinary skill in the art that a lesser or a greater number of second reinforcing members 220 may be employed in a particular application. Preferably, each second reinforcing member 220 is generally cylindrical or rod-like and is formed of a high strength material, such as steel, stainless steel, aluminum or an aluminum alloy, a composite resin material a polymeric material or the like and preferably has a diameter in the range of one-quarter inch to two inches again, depending on the particular end application for the elongated pole member 210. Note that in the second embodiment, the interior of the first reinforcing member 214 does not contain the ground tire rubber mixture 212.

A fifth embodiment of the elongated pole member 510 is illustrated in FIG. 6. The elongated pole member 510 is formed of a ground tire rubber mixture 512 which is substantially the same as the mixture 12 described above in connection with the first embodiment and includes a first reinforcing member 514 which is substantially the same as the first reinforcing member 14 described above in connection with the first embodiment. The fifth embodiment further includes, four second reinforcing members 520 which are generally equally circumferentially spaced around and in an abutting relationship with the exterior radial surface of the first reinforcing member 514 in substantially the same manner as with the second embodiment shown in FIG. 3. However, unlike the second embodiment, in the fifth embodiment the interior of the first reinforcing member 514 is filled with the ground tire rubber material 512a.

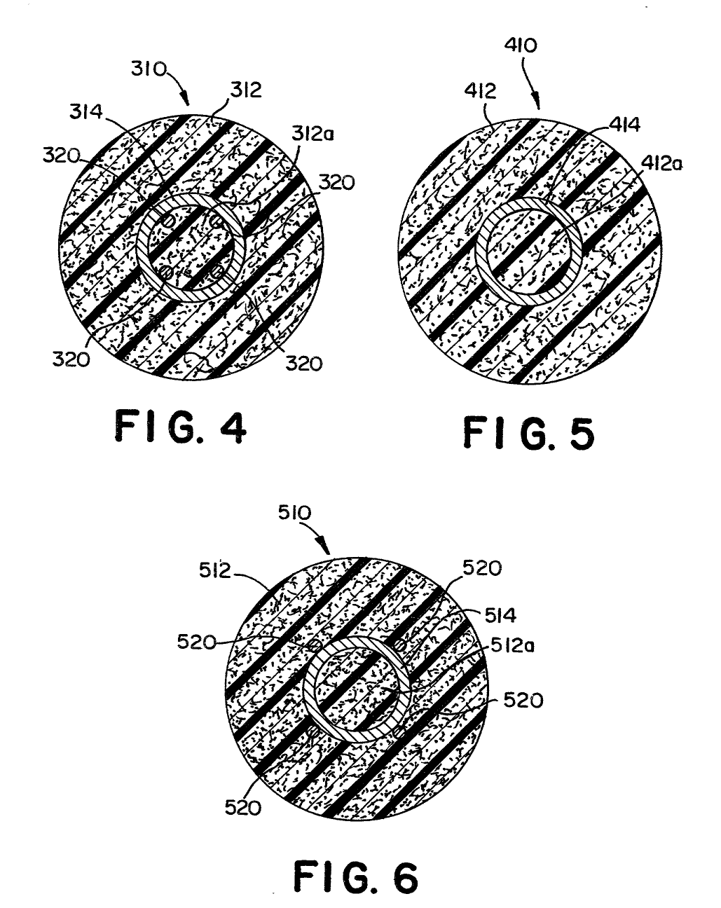

A third embodiment of the elongated pole member 310 is illustrated in FIG. 4. The elongated pole member 310 is substantially the same as the elongated pole member 510 of the fifth embodiment shown in FIG. 6. However, in the third embodiment, each of the second reinforcing members 420 are generally circumferentially spaced and are in engagement with the interior circumferential surface of the first reinforcing member 314. As shown, the interior of the first reinforcing member 314 is also filled with the ground tire rubber mixture 312a.

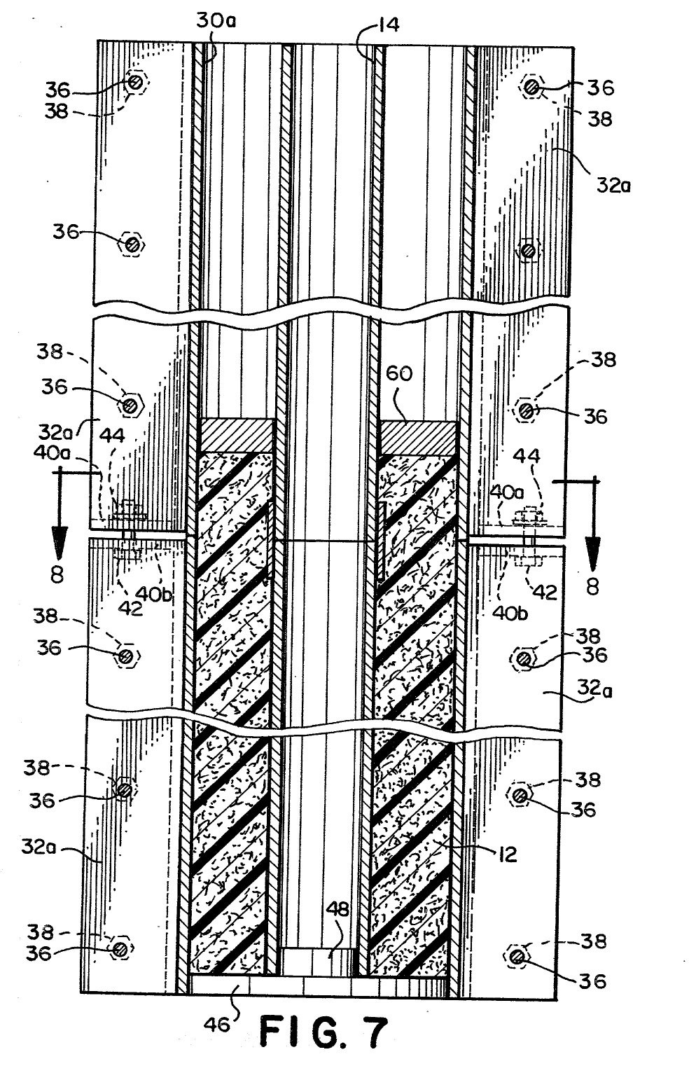

FIGS. 7-9 illustrate some of the features of a process for making an elongated member such as the elongated pole member 10 as described above using the above-described ground tire rubber mixture 12. The method as hereinafter described relates to the making of a generally cylindrical elongated pole member 10 having a generally circular cross-section and including a first reinforcing member 14 as illustrated in FIGS. 1 and 2. It will, however, be appreciated by those of ordinary skill in the art that the below described method is equally applicable to the other embodiments of the elongated pole member as illustrated in FIGS. 3-6, as well as to other elongated members having other shapes, dimensions and the like.

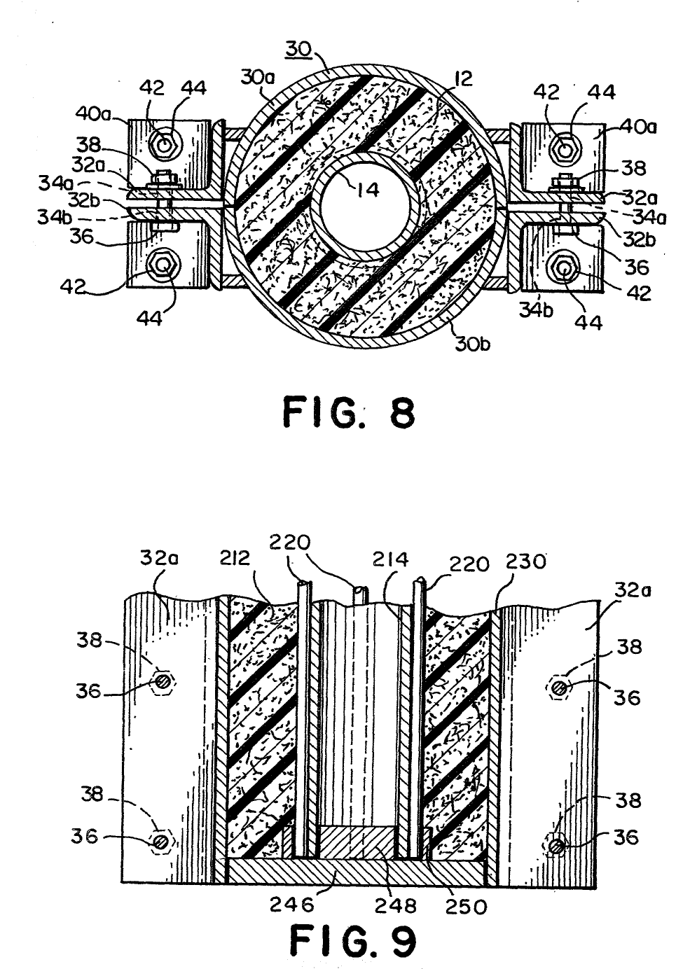

In the present embodiment, the elongated pole member 10 is made using an elongated, generally cylindrical mold 30. In the present embodiment, the mold 30 is formed of two mold halves 30a, 30b which together form a generally cylindrical cavity. Preferably, the mold halves 30a, 30b are formed of a high strength material such as steel, stainless steel or the like. The opposite sides of each of the mold halves 30a, 30b each include an outwardly extending flange member 32a, 32b. The flange members 32a, 32b extend along the entire length of the mold halves 30a, 30b as shown in FIG. 7. Preferably, the flange members 32a, 32b are made of the same high strength material as the mold halves 30a, 30b and are secured to the mold halves 30a, 30b by any suitable known method, such as welding. As best shown in FIG. 8, each of the flanges 32a, 32b includes a series of generally equally spaced circular openings 34a, 34b extending completely therethrough. The openings 34a, 34b are located so that when the mold halves 30a, 30b are placed together to form the mold 30 each of the openings 34a in the flanges 32a associated with the first mold half 30a are precisely aligned with one of the openings 34b in the flanges 32b associated with the second mold half 30b. In this manner, a plurality of bolts 36 or other suitable securing members may extend through each of the aligned openings 34a, 34b to engage a series of nuts 38 which when tightened on the bolts 36 causing the flanges 32a, 32b to tightly clamp together the mold halves 30a, 30b to form essentially an integrated, unitary mold 30. In the present embodiment, the mold halves 30a, 30b are made from existing predetermined lengths of steel pipes having the appropriate diameter for the elongated pole member to be formed. In one embodiment, and only by way of example, steel pipes of a length of ten feet are employed. If the length of an elongated pole member to be made is to exceed ten feet then two or more molds 30 are attached together. The distal ends of each of the flanges 32a, 32b include a series of generally perpendicular flanges 40a, 40b. Each of the perpendicular flanges 40a, 40b includes suitable openings for receiving bolts 42 which when attached to nuts 44, secure the abutting molds together in a tight fitting engagement as shown in FIG. 7 to create a mold of any desired length.

A first or base end of the mold 30 is closed by a generally circular base plate 46 having an outer diameter which is substantially the same as the inner diameter of the mold 30. The base plate 46 includes an inwardly extending generally cylindrical portion 48 which has an outer diameter which is substantially same as the inner diameter of the first reinforcing member 14. The base plate 46 may be secured to the end of the mold 30 in any suitable manner including welding or by some other mechanical attachment device (not shown). With the base plate 46 secured to the end of the mold 30, the first reinforcing member 14 may be positioned within the mold 30 as shown in FIG. 7 and is thereby held in place by engagement with the inwardly extending cylindrical portion 48 of the base plate 46.

FIG. 9 illustrates an alternate embodiment of a base plate 246 which includes both an inwardly extending cylindrical portion 248 for engaging the first reinforcing member 214 and a generally annular inwardly extending flange portion 250 which engages and retains the second reinforcing members 220 against the exterior surface of the first reinforcing member 214 to hold the second reinforcing members 220 in place as shown in FIG. 9. In the alternate arrangement of FIG. 9, the remainder of the mold 230 is as described above in connection with the embodiment shown in FIGS. 7 and 8.

In making an elongated pole member 10, the mold 30 may be placed in either a horizontal orientation or a vertical orientation. In the following description, the mold 30 is placed in a vertical orientation with the base plate 46 forming the lowest portion of the mold 30 and with the upper end of the mold being generally open. A hydraulic ram assembly illustrated schematically as 60 is employed for compacting the ground tire rubber mixture 12 within the mold 30, as will be hereinafter be described. The precise structure and operational details of the hydraulic ram assembly 60 are not necessary for a complete understanding of the present invention. It will be appreciated by those of ordinary skill in the art that some other compacting mechanism, other than the hydraulic ram assembly 60 may alternatively be employed, if desired.

In making an elongated pole member 10, the interior surfaces of the mold 30 are initially coated with a suitable release agent of a type well known to those of ordinary skill in the art. The mold 30 is then assembled by bolting together the two mold halves 30a, 30b with the base plate 46 secured to one end as shown in FIG. 7. The mold 30 is then placed in a vertical orientation with the base plate 46 on the bottom and the open end of the mold 30 extending upwardly.

All of the components of the ground tire rubber mixture 12 as described above are placed in a mixer, such as a Stow mixer and are mixed together for a predetermined period of time so that the components, particularly the urethane polymer binder are thoroughly mixed. Preferably, the predetermined time period will be in the range of from 10-30 minutes, but the time could vary depending upon the precise ratio of the various components of the mixture and other factors including the ambient temperature and humidity. The preferred temperature for mixing the components is about 70° F. However, the temperature may be selected to be high enough to melt or at least soften the polymeric filler so that the polymeric filler also serves to form a binder with the ground tire rubber. If the desired, a curing agent or catalyst of no greater then 1% by volume of the mixture may be added to accelerate the set time for the mixture.

Once the mixture 12 has been thoroughly mixed, the mixture 12 is poured into the mold 30. Once the mold 30 has been filled by the mixture to a predetermined height the hydraulic ram assembly 60 is employed to compress the mixture within the mold 30 as shown in FIG. 7. Preferably, the pressure applied by the hydraulic ram assembly 60 is in the range of about 80 lbs. per sq. inch to about 500 lbs. per sq. inch and preferably will be applied between 10 and 30 minutes while the mixture 12 cures. The precise amount of pressure applied by the hydraulic ram assembly 60 and the amount of the time for which the pressure is applied to the mixture 12 may vary depending upon the ratio of the components within the mixture 12 and other factors such as environmental conditions. Once the mixture 12 has initially cured, the hydraulic ram assembly 60 is removed and the next batch of uncured ground tire rubber mixture 12 is poured on top of the cured mixture, with the process being repeated until the entire pole of the desired length has been made. For example, if the desired pole length is 50 ft., the process would be repeated a total of five times with approximately 10 ft. of the cured ground tire rubber mixture 12 being completed in each batch. Once the final compaction of the ground tire rubber mixture 12 has been completed, pressure from the hydraulic ram assembly continues to be applied to the mixture 12 within the mold for an additional period of between about two hours and about twenty-four hours or until the curing of the ground tire rubber mixture 12 has been completed. Compaction of the ground tire rubber mixture in this manner provides for a denser, finished pole.

Removal of the finished elongated pole member 10 from the mold 30 is completed by removing the nuts and bolts 36, 38 and separating the two mold halves 30a, 30b.

From the foregoing description, it can be seen that the present invention comprises an elongated member, such as an elongated pole member, formed of a ground tire rubber mixture and a method of making such an elongated member. It will be appreciated by those of ordinary skill in the art that changes and modifications may be made to the embodiments of the invention as described above. It should be clearly understood, therefore, that the present invention is not limited to the particular embodiments disclosed, but is meant to cover all aspects of the invention as set forth in the appended claims.

1. A mixture comprising:
at least about 15% by volume of ground scrap tire rubber;
less than about 80% by volume of a ground polymeric filler;
at least about 5% by volume of a urethane binder;
a fire retardant; and
an ultraviolet stabilizer.

2. The mixture as recited in claim 1 wherein the ultraviolet stabilizer comprises less than about 6% by volume.

3. The mixture as recited in claim 1 wherein the fire retardant comprises less than about 3% by volume.

4. The mixture as recited in claim 1 further including a curing agent which comprises less than about 3% by volume.

5. The mixture as recited in claim 1 wherein the ground scrap tire rubber comprises about 65% by volume, the ground polymeric filler comprises about 25% by volume, the ultraviolet stabilizer comprises about 1% by volume, the fire retardant comprises about 1% by volume and the binder comprises about 5% by volume.

6. A mixture comprising: ground scrap tire rubber of about between 15% and 85% by volume; ground polymeric filler of about between 10% and 80% by volume; and a urethane binder of about 5% by volume.
